(19) United States
(12) Patent Application Publication
(10) Pub. No.: US 2010/0233916 A1
(43) Pub. Date: Sep. 16, 2010

(54) Electrical contacting device, in particular for electronic circuits, and electrical/electronic circuit

(76) Inventor: Peter Kimmich, Schoenaich (DE)

Correspondence Address: KENYON & KENYON LLP, ONE BROADWAY, NEW YORK, NY, 10004, US

(21) Appl. No.: 12/308,323

(22) PCT Filed: Jun. 12, 2007
(86) PCT No.: PCT/EP2007/063387

§ 371 Date: Apr. 22, 2010

(30) Foreign Application Priority Data
Dec. 28, 2006 (DE) 10 2006 062 485.6

(51) Int. Cl. H01R 4/48

(52) U.S. Cl. 439/816

(57) ABSTRACT

An electrical contacting device, e.g., for electronic circuits, has an electrically non-conductive substrate on which at least one electrically conductive contact element is situated. The contacting device is designed as a touch contacting device, while the substrate is made of or has an elastically resilient material for applying a contact pressure.

### BACKGROUND OF THE INVENTION

1. Field of the Invention

The present invention relates to an electrical contacting device, e.g., for electronic circuits, having an electrically non-conductive substrate on which at least one electrically conductive contact element is situated.

2. Description of Related Art

Electrical contacting devices of the above-named type are widely known. For example, there are printed circuit boards (PCBs) that have electrically conductive conductor paths that are situated on an electrically non-conductive substrate. To make contact with electrical/electronic components, the latter are connected to the conductor paths of the circuit board, for example by bonding, bonding using conductive adhesives, welding, cold contacting techniques such as cut-and-clamp connecting, flanging, plug connecting or soldering (electrical).

Bonding and welding are serial processes. That means that bonded or welded connections must be produced one after another, which causes the production or process costs to be high and the production cycle times to be long. Furthermore, special automatic bonding or welding machines must be available or be acquired.

Simultaneous production of a plurality of soldered connections, for example using a wave-flow bath, requires expensive furnace processes, and often can be employed only with great difficulties or not at all when using different substrates and/or different prior processes.

Cold contacting techniques are mechanical connections, such as spring contacts, flanging, or cut-and-clamp connections. Contacting devices of this sort can only be miniaturized to a limited degree, and require high manufacturing precision and correspondingly high tool costs.

Known conductive adhesives that are applied to the substrate have limited current transmitting capability, and likewise require expensive furnace processes for attachment.

Also known are contacting devices made of conductive rubber, such as zebra rubber, convergent strands (LCD) or “board-to-board” contacts, which however only make contact from top to bottom, i.e., they only implement an electrical connection between two electrical/electronic components situated on opposite sides of a substrate. Furthermore, such conductive rubber contacts exhibit poor junction resistance.

### BRIEF SUMMARY OF THE INVENTION

The present invention provides an electrical contacting device configured as a touch contact device, the substrate being made of elastically resilient material or having such material to apply contacting pressure. Advantageously, the substrate is thus made of an elastically resilient material or has such material, so that in a touch contact of the electrically conductive contact element, which is situated on the substrate, with one or more opposing contact elements of an electrical/electronic component with which contact is to be made, the substrate preferably yields elastically in the area of the con-tact element. For example, if the electrical contacting device is situated on part of the housing of an electronic circuit and the electrical/electronic component with which contact is to be made is situated in another part of the housing, when the two housing parts are fitted together a stable contact is produced automatically between the contact element and the electrical/electronic component by the electrical/electronic component being pressed against the contact element, causing the latter to be forced back due to the elastically resilient substrate, while a contacting pressure that presses the contact element against the electrical/electronic component is produced due to the elasticity of the substrate. This advantageous design of the contacting device makes it possible to produce a continuous, reliable electrical connection in a simple manner using a touch contact, while manufacturing tolerances and/or positional tolerances of components being contacted, due to manufacturing requirements, are compensated for automatically. The advantageous contacting device constitutes in this case a cold contacting technique, which enables simple and quick assembly and contacting of a plurality of electrical/electronic components.

Advantageously, the contacting element is designed in such a way that an electrical connection is producible in the plane of the substrate. Hence there is provision, for example, for an electrical connection to be producible between two electrical/electronic components that are situated side-by-side on one side of the substrate, using the contact element. An electrical connection from “left to right” in one plane is thus advantageously producible.

Advantageously, the contact element is in the form of a conductor path. The latter is advantageously situated on the substrate in such a way that a desired electrical connection may be produced.

According to a refinement of the present invention, a plurality of contact elements that form a conductor path structure is situated on the substrate. That makes complex circuits possible, which may produce electrical connections in a simple manner through touch contact, according to the design of the present invention. Here the electrical/electronic components of a circuit are placed advantageously in corresponding receptacles of a housing part, in such a way that they are aligned in that housing part. The electrical contacting device according to the present invention is then placed on top, the latter advantageously having means of centering, such as centering pins or cutouts, which make it possible to align the electrical contacting device in the housing part. The electrical contacting device or the substrate itself may also have a shape and/or external contour that aligns it in the housing part. Next, the contacting device is pressed against the electrical/electronic components by a mating part, such as, for example, a housing cover, which has a suitable shape and thereby advantageously contacts part or all of the back surface of the electrical contacting device. The contact elements or conductor path structure are pressed against the corresponding mating contacts of the electrical/electronic components by the pressing of the housing cover against the contacting device or the housing part. Continuity of the pressure force can be ensured by using clasps, clips, springs, or even screws. Since the substrate is made of an elastically resilient material, as described above, and thereby yields elastically when the pressure force is applied in the area of the particular contact element or point of contact with an electrical/electronic component, a reliable electrical connection to each individual mating contact of the electrical/electronic components is ensured, since manufacturing tolerances and/or positional tolerances are compensated for.

According to a refinement of the present invention, the contact element or the conductor path structure is formed by a structured metal foil. For example, to produce the contact element or the conductor path structure, an electrically conductive metal foil is placed on the substrate and is then structured by etching. Alternatively, the conductor path structure can also be produced by stamping, hot stamping, or other material removing methods known to those skilled in the art, so that individual electrically conductive areas separated from each other result, which are employed as conductor paths. To protect against corrosion, the foil used advantageously has a precious metal surface or other chemically inactive surface known to those skilled in the art.

In another example embodiment of the present invention, the contact element or the conductor path structure is advantageously formed by an electrically conductive printed coating applied to the substrate. For example, a semiconductive carbon lacquer or metal-filled paint is applied to the substrate in a silkscreen printing process in which the conductor path structure is produced because of the shape of the screen employed. Furthermore, it is conceivable for the substrate to have a certain “three-dimensional” form, so that its shape is not flat. Furthermore, the substrate may be of a right-angled design, causing the contact elements situated on the substrate to be situated in two planes perpendicular to each other.

According to a refinement of the present invention, the electrical contacting device is designed as a contacting mat. That means that the contacting device is an essentially easily malleable, flexible element, enabling the contacting device to be used in more than one plane. For example, if the contacts of the electrical/electronic components to be contacted are located in two different planes, for example if they are situated perpendicular or obliquely to each other, the contacting mat can be placed or shaped accordingly, so that touch contact is possible in both planes. The different planes here may be situated both side-by-side and one directly above the other. Aside from the simplicity of handling, the flexible design of the contacting device as a contacting mat results in another substantial benefit in terms of compensating for manufacturing tolerances and/or positional tolerances. Advantageously, the substrate is made of an elastomer material or includes such a material.

According to a refinement of the present invention, the substrate forms at least one seal. Because of this elastically resilient material, the substrate may be situated in a housing in such a way that it acts as a seal between two housing parts. Advantageously, to that end the substrate has at least one sealing projection, which preferably engages a recess in the housing to enable an especially effective seal.

The electrical/electronic circuit according to the present invention advantageously has at least two electrical/electronic components, which are electrically connected to each other by a contacting device described earlier. The elastically resilient material of the contacting device, as described above, enables especially advantageous compensation for manufacturing tolerances and/or positional tolerances of the electrical/electronic components, and of the housing parts of the electronic circuit that receive these components.

According to a refinement of the present invention, the components here are situated on one side of the substrate, so that an electrical connection as described above is produced from “left to right” in one plane.

Advantageously, the contacting device is clamped between two housing parts of the electronic circuit, so that on the one hand a pressure is exerted on the contacting device, which presses its contact elements against the corresponding mating contact elements of the electrical/electronic components, and on the other hand, the contacting device or the elastically resilient substrate of the contacting device is used as a sealing means.

### BRIEF DESCRIPTION OF THE SEVERAL VIEWS OF THE DRAWINGS

FIG. 1 shows an exemplary embodiment of a contacting device according to the present invention.

FIG. 2 shows an exemplary embodiment of an electronic circuit having a contacting device according to the present invention.

### DETAILED DESCRIPTION OF THE INVENTION

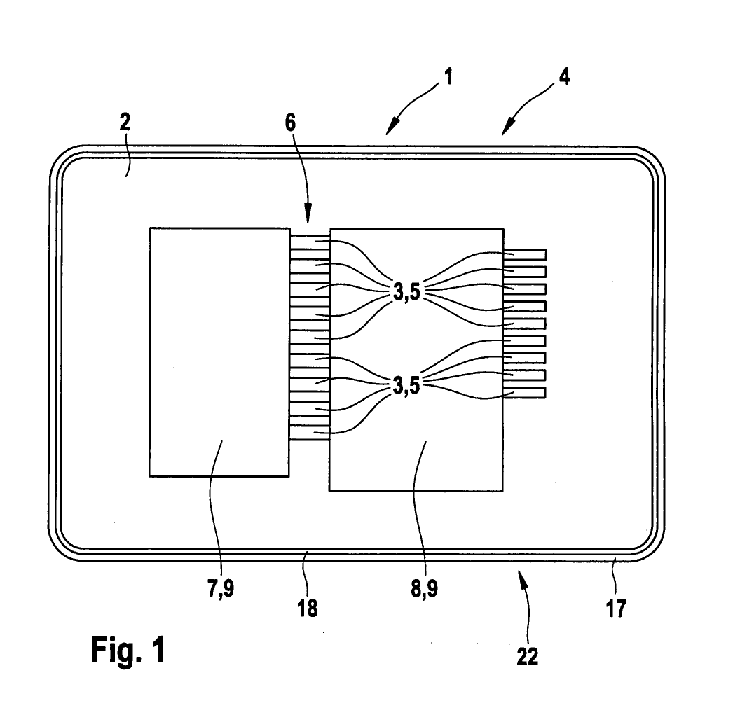

FIG. 1 shows a top view of an exemplary embodiment of an electrical contacting device 1 according to the present invention. Contacting device 1 has an essentially rectangular-shaped substrate 2, on which a plurality of contact elements 3 is situated. Contacting device 1 is designed in this case as a touch contacting device 4, so that the contact elements 3 act as touch contact elements. Substrate 2 in the present exemplary embodiment is made of an elastically resilient material, so that if a pressure is exerted on contact elements 3 perpendicular to the plane of the paper, they are pushed back, i.e., the substrate yields elastically, and thus the contact elements are pressed into the material of substrate 2. That causes a secure and durable electrical connection to be implemented to one or to each electrical/electronic component to be contacted thereby, or to the mating contact of the component that is to be contacted, while manufacturing tolerances and/or positional tolerances are compensated for.

Contact elements 3 depicted in FIG. 1 each form a short conductor path 5, which provides an electrical connection of two electrical/electronic components that are situated side-by-side in a plane, where a mating contact element of each of two components is brought into touch contact with a contact element 3 or a conductor path 5, and thus the components are electrically connected to each other. The necessary contacting pressure for a reliable and durable electrical connection is ensured by the elastically resilient material of substrate 2. In the present exemplary embodiment, contacting elements 3 form a simply designed conductor path structure 6. But more complicated conductor path structures for complex electronic circuits are naturally also conceivable.

Contact elements 3 may be produced, for example, from a metal foil, for example a copper foil, and may be structured by etching processes, stamping, hot stamping, or other material removing methods known to those skilled in the art, so that the individual contact elements 3 or areas separated from each other are produced, which form the conductor paths 5. To protect against corrosion, the metal foil advantageously has a precious metal surface or other chemically inactive surface. The metal foil or the contact elements 3 may be bonded to the substrate, or may be joined to it by a coating process. Alternatively, contact elements 3 may also be produced by a silkscreen printing method, wherein a conductive carbon lacquer or metal-filled paint for example is applied to electrically non-conductive substrate 2. Substrate 2 itself is advantageously made of an elastomer material that is electrically non-conductive. Depicted contact device 1 also has two cutouts 7 and 8, which serve, for example, for passing through electrical/electronic components or housing parts or for cooling. Cutouts 7, 8 may also be designed as centering means 9, in such a way that they serve to align or center contacting device 1 in a housing.

The advantageous contacting device 1 makes it possible to establish an electrical connection reliably and durably to several electrical/electronic components simultaneously in a simple manner, while the spatial placement of electrical/electronic components can be designed significantly more flexibly, which also results in advantages in electromagnetic compatibility (EMC). The touch contacting makes an effective parallel assembly and joining process possible, wherein manufacturing tolerances and/or positional tolerances are advantageously compensated for.

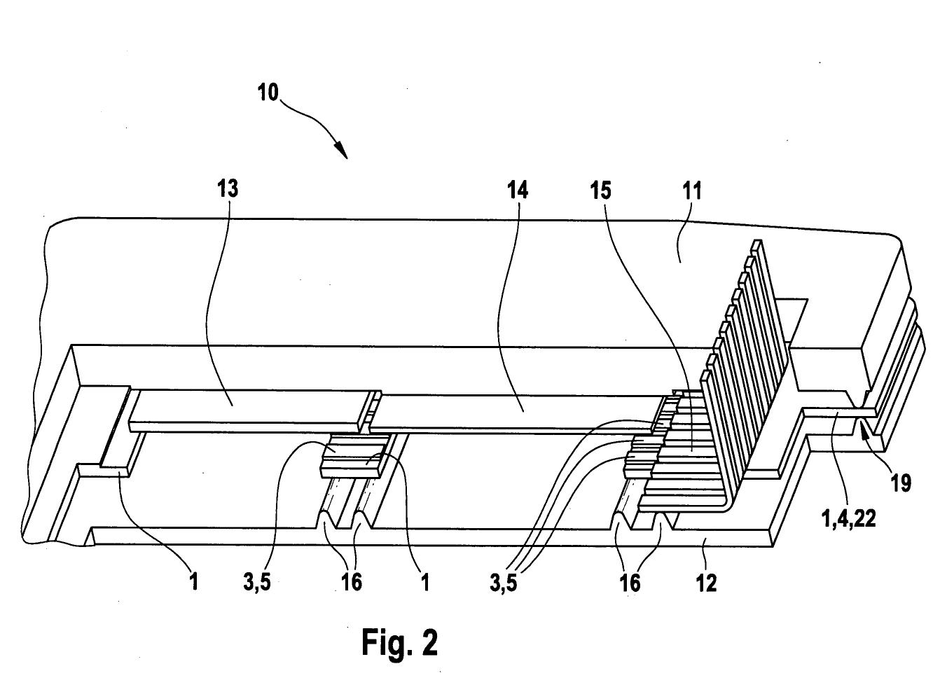

FIG. 2 shows a perspective view of an exemplary embodiment of an advantageous electronic circuit 10 that has a housing part 11 and a housing cover 12. The electronic circuit 10 depicted in FIG. 2 is shown obliquely from below. Situated between housing part 11 and housing cover 12 is the contacting device 1 known from FIG. 1, and a first electrical/electronic component 13 and a second electrical/electronic component 14 and a pressed screen 15 leading from housing part 11. Components 13 and 14 and pressed screen 15 lie with corresponding mating contacts on contact elements 3 of contacting device 1 or touch contacting device 4. In the depicted exemplary embodiment, component 13 is designed as a LTCC (low temperature cofired ceramic), and component 14 as a DBC (direct bonded copper) component. Advantageously, housing part 11 and housing cover 12 are joined to each other using screws, housing part 11 and housing cover 12 being pressed against each other. At the same time, housing cover 12 has projections 16 in the area of contact elements 3 of contacting device 1, which press contacting device 1 or substrate 2 against components 13, 14 and housing part 11, whereby the touch contact is realized. The elastic design of substrate 2 produces a contacting pressure for each electrical connection, which ensures reliable and durable touch contact, while manufacturing tolerances and/or positional tolerances are compensated for, as already stated.

When assembling electronic circuit 10, components 13, 14 and pressed screen 15 are first placed in receptacles in housing part 11. Because of appropriate shaping of the receptacles in housing part 11, components 13, 14 and pressed screen 15 are spatially fixed with sufficient precision. Next, touch contacting device 4 or contacting device 1 is placed on top. Because of its shape, for example because of centering means 9, contacting device 1 or touch contacting device 4 is correctly positioned for reliable touch contacting of components 13, 14 and pressed parts 15. Finally, housing cover 12 is pressed onto contacting device 1 or touch contacting device 4. The necessary contact force for the electrical touch contact is thereby introduced. Continuity of the necessary pressure force can be ensured by clips, clasps, springs, or even screws, as stated earlier.

As depicted in FIG. 1, contacting device 1 has at its edge zone 17 a sealing projection 18 that extends around the entire periphery. Sealing projection 18 is of beadlike design, and is clamped between housing part 11 and housing cover 12 when those two parts are fitted together, so that a seal 19 is formed. Alternatively or in addition, housing part 11 and the housing cover may also each have a sealing projection 20, 21, between which substrate 2 is clamped. Because of the elastically resilient material, a reliable seal 19 is implemented in both cases.

Substrate 2 may also be shaped in such a way that contact elements 3 are situated in different planes, for example parallel to or at an angle to each other.

Advantageously, contacting device 1 or touch contacting device 4 is designed as a contacting mat 22, which is flexibly deformable. Thus even components of electronic circuit 10 that are in a different plane parallel or oblique to the plane of components 13, 14 may be contacted in a simple manner using the same contacting device without the shape of the substrate needing to be adjusted beforehand, compensating for manufacturing tolerances and/or positional tolerances and simplifying assembly.

1-14. (canceled)

15. An electrical contacting device for an electronic circuit, comprising:
an electrically non-conductive substrate; and
at least one electrically conductive contact element situated on the substrate;
wherein the contacting device is configured as a touch contacting device, and wherein the substrate includes an elastically resilient material configured for applying a contacting pressure.

16. The electrical contacting device as recited in claim 15, wherein the contact element is configured in such a way to achieve an electrical connection in the plane of the substrate.

17. The electrical contacting device as recited in claim 16, wherein the contact element is configured as a conductor path.

18. The electrical contacting device as recited in claim 16, wherein a plurality of contact elements that form a conductor path structure is situated on the substrate.

19. The electrical contacting device as recited in claim 18, wherein the contact elements are made from a structured metal foil.

20. The electrical contacting device as recited in claim 18, wherein the contact elements are made of an electrically conductive printed coating applied to the substrate.

21. The electrical contacting device as recited in claim 18, wherein the contacting device is configured as a contacting mat.

22. The electrical contacting device as recited in claim 18, wherein the substrate has a centering arrangement.

23. The electrical contacting device as recited in claim 18, wherein the substrate is made of an elastomer material.

24. The electrical contacting device as recited in claim 18, wherein the substrate forms at least one seal.

25. The electrical contacting device as recited in claim 24, wherein the substrate has at least one sealing projection.

26. An electrical circuit, comprising:
at least two electrical components; and
an electrical contacting device configured to electrically connect the at least two electrical components, wherein the contacting device includes:
an electrically non-conductive substrate; and
at least one electrically conductive contact element situated on the substrate;
wherein the contacting device is configured as a touch contacting device, and wherein the substrate includes an elastically resilient material configured for applying a contacting pressure, and wherein the contact element is configured in such a way to achieve an electrical connection in the plane of the substrate.

27. The electrical circuit as recited in claim 26, wherein the at least two electrical components are situated on one side of the contacting device.

28. The electrical circuit as recited in claim 27, wherein the contacting device is clamped between a housing part and a housing cover.
